(19) United States
(12) Patent Application Publication
(10) Pub. No.: US 2010/0270751 A1
(43) Pub. Date: Oct. 28, 2010

(54) ANTI-ROLL RIBBED SEAL

(75) Inventors: Derril A. Loe, Williamston, MI (US); Richard F. Olenzek, Farmington Hills, MI (US); Charless S. Davis, Livonia, MI (US)

Correspondence Address: VIVACQUA LAW, PLLC, 455 East Eisenhower Parkway, Suite 200, ANN ARBOR, MI, 48108, US

(73) Assignee: GM GLOBAL TECHNOLOGY OPERATIONS, INC., Detroit, MI (US)

(21) Appl. No.: 12/428,942

(22) Filed: Apr. 23, 2009

(51) Int. Cl. F16J 9/20

(52) U.S. Cl. 277/436

(57) ABSTRACT

The present invention provides a resilient, fluid-tight seal for shafts, pistons and the like having a plurality of radially oriented, spaced-apart ribs or webs extending between adjacent oblique circular flanges or features of a seal. The radially oriented ribs or webs provide added stiffness to the flanges or features to prevent them from rolling under during assembly procedures but do not increase the radial spring constant and thus do not appreciably increase the drag created by the seal on a shaft or piston.

### FIELD

The present disclosure relates to resilient, fluid tight seals for rotating shafts, sliding pistons and the like and more particularly to resilient, fluid tight seals having ribs which resist rolling and deformation typically occurring during assembly which can compromise the integrity and longevity of the seal.

### BACKGROUND

The statements in this section merely provide background information related to the present disclosure and may or may not constitute prior art.

A wide variety of mechanical devices such as motors, engines, transmissions, valves, actuators and hydraulic components require resilient seals, either to exclude foreign matter, maintain fluids such as lubricating oil and hydraulic fluid within the device and often both. For obvious reasons, such seals are typically circular, to accommodate shafts and pistons, and are fabricated of an elastomer such as rubber or synthetic materials such as polytetrafluoroethylene (PTFE). The cross-sections of such seals are as varied as their applications: from the simple circle of an O-ring seal to multiple ribs or flanges sized and oriented uniquely for application specific purposes.

In many applications such as transmissions, differentials and transaxles, such seals include a relatively rigid, often metal, component to which the actual resilient seal structure is bonded. Such seals are installed as male components into openings, bores and counterbores after which a shaft, piston or the like is installed in or through the resilient portion of the seal. Such resilient portions, as noted above, may contain one of more ribs or flanges. As a shaft or piston is installed in or through the seal, these ribs or flanges may deform and roll under in the direction of travel of the shaft or piston. Since the deformation and rolling is generally caused by the end of the shaft or piston, or a step or shoulder therein, unless the shaft or piston is backed out and re-inserted, there is only a small likelihood the seal will return to its intended shape. More problematic is the fact that such seals are frequently deep inside a component or at least hidden by the shaft or components attached to it such as a dust shield. Thus it can be very difficult to detect a deformed seal at the time of installation.

After a seal failure, evidenced by a fluid leak, it can be all too easy to detect the seal failure, but at this juncture, repair can be time consuming and costly. The present invention is directed to improving resilient shaft and piston seal integrity by reducing the likelihood of seal deformation during assembly procedures.

### SUMMARY

The present invention provides a resilient, fluid-tight seal for shafts, pistons and the like having a plurality of radially oriented, spaced-apart ribs or webs extending between adjacent oblique circular flanges or features of a seal. The radially oriented ribs or webs provide added stiffness to the flanges or features to prevent them from rolling under during assembly procedures such as installation of a shaft or piston but do not increase the radial spring constant and thus do not appreciably increase the drag created by the seal on a shaft or piston.

Thus it is an object of the present invention to provide a resilient seal for shafts, pistons and the like having a plurality of radially oriented ribs extending between adjacent flanges or features of the seal.

It is a further object of the present invention to provide a resilient seal for shafts, pistons and the like having a plurality of radially oriented, spaced apart ribs extending between adjacent flanges or features of the seal.

It is a still further object of the present invention to provide a seal for shafts, pistons and the like having at least a pair of circular features and a plurality of radially oriented ribs extending between such pair of features.

It is a still further object of the present invention to provide a seal for shafts, pistons and the like having at least a pair of circular features and a plurality of radially oriented webs extending between such pair of features.

It is a still further object of the present invention to provide a resilient seal for shafts, pistons and the like having a metal insert, a pair of circular features and a plurality of radially oriented webs extending between such pair of features.

It is a still further object of the present invention to provide a resilient seal for shafts, pistons and the like having a metal insert, a pair of circular features and a plurality of radially oriented ribs extending between such pair of features.

It is a still further object of the present invention to provide a resilient seal for shafts, pistons and the like having a plurality of radially oriented ribs extending between adjacent flanges or features of the seal which reduces the likelihood of a seal flange rolling under during an assembly procedure.

It is a still further object of the present invention to provide a resilient seal for shafts, pistons and the like having a plurality of radially oriented ribs extending between adjacent flanges or features of the seal which does not appreciably increase the drag created by the seal on a shaft or piston.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a full sectional view of a portion of a final drive assembly including a differential and drive axle incorporating a shaft seal according to the present invention;

FIG. 2 is a perspective view of a shaft seal according to the present invention;

FIG. 3 is a fragmentary, sectional view of a shaft seal according to the present invention;

FIG. 4 is a full sectional view of a portion of an automatic transmission incorporating a piston seal according to the present invention;

FIG. 5 is a fragmentary perspective view of a piston seal according to the present invention; and

FIG. 6 is a fragmentary, sectional view of a piston seal according to the present invention.

### DETAILED DESCRIPTION

The following description is merely exemplary in nature and is not intended to limit the present disclosure, application, or uses.

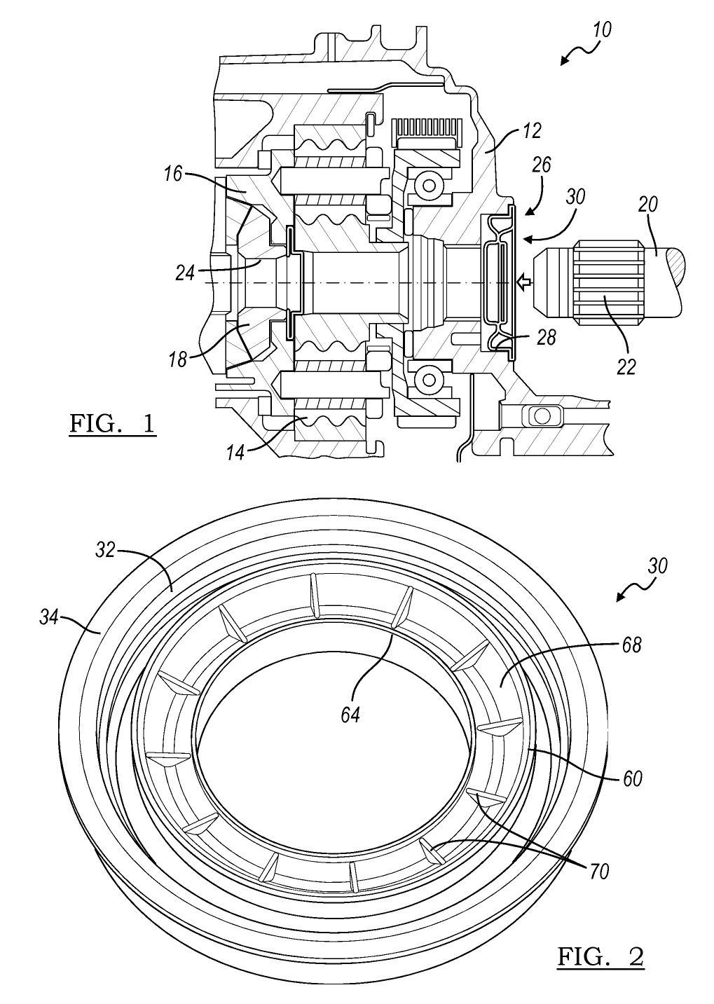

With reference to FIG. 1, a portion of a final drive assembly including a differential and drive axle is illustrated and generally designated by the reference number 10. The final drive assembly 10 includes a housing 12 which receives, locates and protects components such as input or driven gear 14 which is coupled to and drives a cage differential 16 having a pair of output bevel gears 18, one of which is illustrated in FIG. 1. The output bevel gear 18 is drivingly connected to an axle 20 which is shown in a pre-assembly condition. The axle 20 includes, for example, external splines 22 which engage complementary internal splines 24 in the bevel gear 18.

The housing 12 defines a bore or circular opening 26 which accommodates the axle 20 and a co-axial counterbore 28 which receives a fluid tight shaft seal 30 according to the present invention. The shaft seal 30 provides a fluid tight seal between the rotating axle 20 and the housing 12.

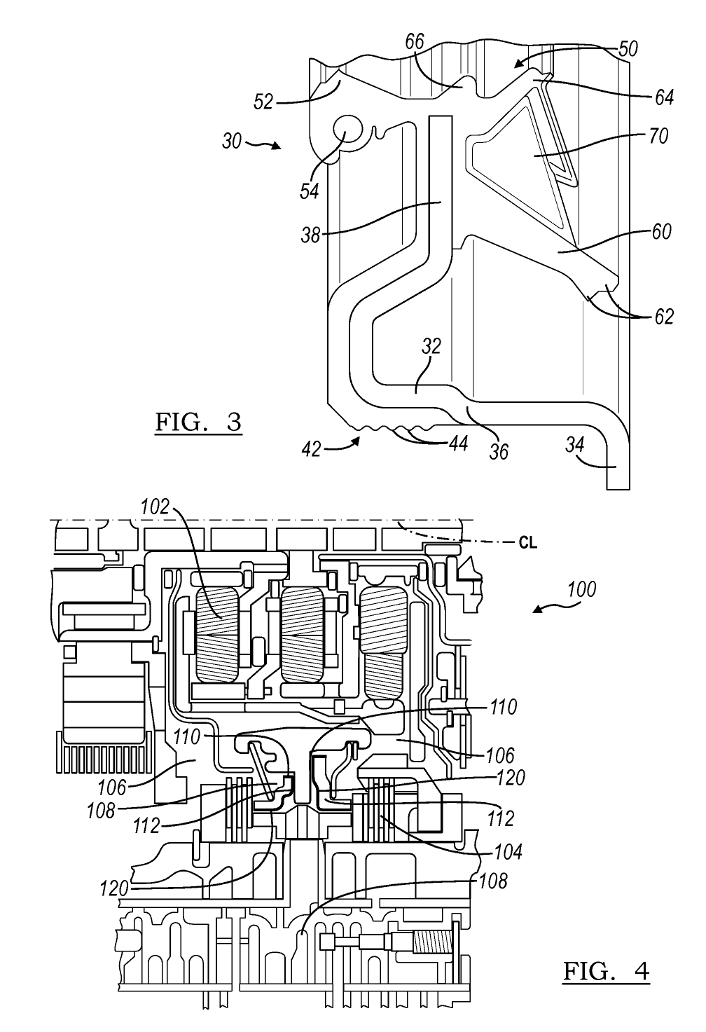

Referring now to FIGS. 2 and 3, the fluid tight shaft seal 30 includes a complexly formed metal annulus 32 having an outer, radially extending flange 34, an intermediate shoulder 36 and an inner, radially extending flange 38. The metal annulus 32 functions as a relatively rigid base or carrier upon which various resilient components of the shaft seal 30 are formed, molded and bonded in accordance with conventional practice. As illustrated in FIG. 1, the outer flange 34 acts as a locating means and is positioned against a shoulder of the counterbore 28 when the seal 30 is installed in the housing 12. The intermediate shoulder 36 provides a relief within which is formed an outer static seal 42 having a plurality of circumferential ribs or convolutions 44 which provide an exterior, fluid-tight seal against the wall of the counterbore 28.

About and adjacent the terminus of the inner, radially extending flange 38 of the metal annulus 32 is an inner seal assembly 50 having an inner seal flange 52 which defines an internal circular opening 54 extending around the flange 52. On the opposite, outer face of the metal annulus 32 is a first longer, oblique flange 60 that typically is capable of engaging the dust shield (not illustrated) on the axle 20. Preferably, the first oblique flange 60 terminates in a pair of offset or asymmetrically arranged tips or ends 62. Disposed radially inwardly from the first oblique flange 60 and oriented at an angle of between about 70 to 95 degrees to it, is a second oblique flange 64. Proximate the end of the metal annulus 32 is a third short rib or bead 66. The length of the second oblique flange 64 is shorter than the first flange 60 but longer than the third rib or bead 66.

The first oblique flange 60 and the second oblique flange 64 cooperatively define or form a triangular recess or channel 68. Extending between the first oblique flange 60 and the second oblique flange 64 in the triangular channel 68 are a plurality of ribs or webs 70. The ribs or webs 70 are radially oriented and are thus generally triangular as illustrated in FIG. 3. The ribs or webs 70 also define a triangle in circumferential cross section: the outer edges of the ribs or webs 70 are narrower or thinner than their bases, that is, their portions merging with the oblique flanges 60 and 64. As illustrated in FIG. 2, it has been found that twelve of the ribs or webs 70 are suitable for use in a typical axle seal. However, it should be understood that the number of ribs or webs 70 utilized in a given seal may be adjusted up or down from this number in light of seal size, seal requirements, assembly issues, seal material characteristics and other engineering and design considerations. Thus the incorporation of as few as four or six ribs or webs 70, or fewer, in a shaft seal 30 and as many as twenty or thirty ribs or webs 70, or more, are all well within the scope of the present invention.

Referring now to FIG. 4, a portion of a typical and exemplary automatic transmission is illustrated and generally designated by the reference number 100. The automatic transmission 100 includes various planetary gear sets 102, friction clutch packs 104 and associated hydraulic actuators 106 and a hydraulic control module 108 having a plurality of logic and flow control valves (not illustrated) that provide controlled flows of pressurized hydraulic fluid to the friction clutch pack actuators 106 and other devices to effect operation of the automatic transmission 100. It will be understood that a lower portion of the automatic transmission 100 is illustrated and that the power transmission components delineated are symmetrical about a centerline CL of the transmission 100. The hydraulic actuators 106 take the form of relatively large annular cylinders 110 which slidably receive complementarily configured annular pistons 112. Disposed adjacent the open ends of the cylinders 110 are annular fluid tight seals 120 which incorporate the present invention.

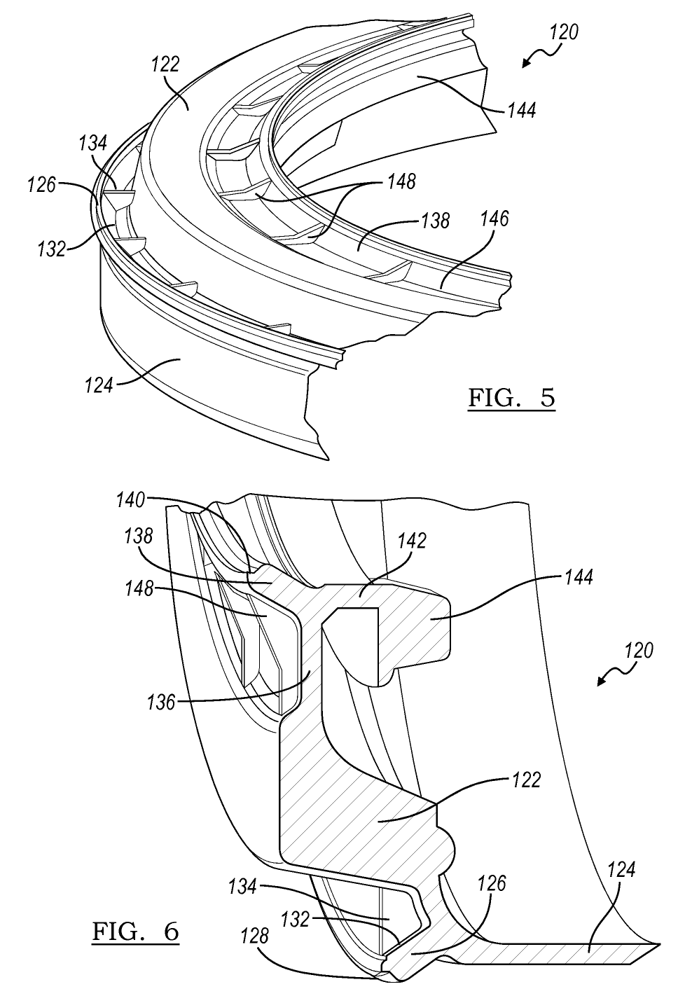

Referring now to FIGS. 5 and 6, the annular fluid tight seal 120 includes a central body portion 122 which narrows to an axially extending, thin wall annular flange 124. Between the central body portion 122 and the thin wall annular flange 124 is a first oblique sealing flange 126 which terminates in an offset tip or nib 128. The central body portion 122 and the first sealing flange 126 define or form a first recess or channel 132 within which a first plurality of radially oriented, spaced apart ribs or webs 134 reside. The ribs or webs 134 provide additional stiffness to the first sealing flange 126 to greatly reduce the likelihood that it will roll under or otherwise deform when the annular seal 120 is being installed in an annular cylinder 110 but do not appreciably change the radial spring rate of the first sealing flange 126 and thus do not increase drag.

Extending radially inwardly of the central body portion 122 of the fluid tight seal 120 is a flat, circular region 136 which merges with and supports, first of all, a second oblique sealing flange 138 which terminates in an offset tip or nib 140 and, second of all, an axially extending flange 142 which merges with and supports an enlarged terminal member 144. The central body portion 122, the flat, circular region 136 and the second oblique sealing flange 138 cooperatively define and form a second recess or channel 146 within which a second plurality of radially oriented, spaced apart ribs or webs 148 reside. Once again, the ribs or webs 148 provide additional stiffness to the second sealing flange 138 to greatly reduce the likelihood that it will roll under or otherwise deform when the annular seal 120 is being installed in a cylinder 108 but do not appreciably change the radial spring rate of the second sealing flange 138 and thus do not increase the drag of the piston 112.

Once again, the number of ribs or webs 134 and 148 will be determined by a variety of engineering considerations and constraints, such as the nominal diameter of the seal, the material of the seal and its characteristics, the desired increase in stiffness, any limitation on such increase in stiffness, installation issues. Due to the much larger diameter of the annular seal 120 than the shaft seal 30, it is anticipated that 24, 30, 36, 40 or more or fewer ribs or webs 134 and 148 may be utilized.

It will thus be appreciated that the fluid tight shaft seal 30 and the piston seal 120 according to the present invention provide greatly improved resistance to rolling and deformation during installation procedures and that they provide this benefit with only a negligible increase in cost an with no changes to existing installation procedures or components.

The description of the invention is merely exemplary in nature and variations that do not depart from the gist of the invention are intended to be within the scope of the invention. Such variations are not to be regarded as a departure from the spirit and scope of the invention and are deemed to be within the scope of the following claims.

What is claimed is:

1. A fluid tight seal for shafts and pistons comprising, in combination,
an annulus defining an axis and a flexible annular seal structure, said flexible seal structure including a first flange oriented obliquely to said axis and a second flange oriented obliquely to said axis and defining a channel with said first flange and a plurality of radially oriented ribs disposed in said channel and extending between said first flange and said second flange.

2. The fluid tight seal of claim 1 wherein said annulus is metal and said first and second flanges extend from one side of said annulus.

3. The fluid tight seal of claim 1 wherein said annulus includes an inner edge and said seal structure further includes a third flange substantially parallel to said second flange and proximate said inner edge of said metal annulus.

4. The fluid tight seal of claim 3 wherein said seal structure further includes a fourth flange substantially parallel to said second flange and proximate said inner edge.

5. The fluid tight seal of claim 1 wherein said ribs are triangular.

6. The fluid tight seal of claim 1 wherein said ribs are triangular in cross section.

7. The fluid tight seal of claim 1 wherein said flexible seal structure includes an outer circumferential seal having a plurality of ribs.

8. A seal resistant to deformation during assembly comprising, in combination,
a shape maintaining annulus defining an axis and having a seal structure bonded thereto, said seal structure including a first flange oriented at a first angle to said axis and a second flange oriented at a second angle to said axis and defining a recess with said first flange and a plurality of radially oriented webs disposed in said recess and extending between said first flange and said second flange, whereby said ribs prevent deformation of said flanges during assembly.

9. The deformation resistant seal of claim 8 wherein said first and said second flanges extend from one face of said annulus.

10. The deformation resistant seal of claim 8 wherein said shape retaining annulus includes an inner edge and said seal structure further includes a third flange substantially parallel to said second flange and proximate said inner edge of said annulus.

11. The deformation resistant seal of claim 10 wherein said seal structure further includes a fourth flange substantially parallel to said second flange and proximate said inner edge.

12. The deformation resistant seal of claim 8 wherein said webs are triangular.

13. The deformation resistant seal of claim 8 wherein said webs are triangular in cross section.

14. The deformation resistant seal of claim 8 wherein said seal structure includes an outer circumferential seal having a plurality of ribs.

15. A roll resistant seal for shafts and pistons comprising, in combination,
an annular carrier defining an axis and having a multiple flange seal structure secured thereto, said seal structure having a first flange oriented obliquely to said axis and a second flange oriented obliquely to said axis and defining a recess with said first flange and a plurality of radially oriented ribs disposed in said channel and extending between said first flange and said second flange.

16. The roll resistant seal of claim 15 wherein said annular carrier is metal and said first and said second flanges extend from one face of said annular carrier.

17. The roll resistant seal of claim 15 wherein said annular carrier includes an inner edge and said seal structure further includes a third flange substantially parallel to said second flange and proximate said inner edge of said annular carrier.

18. The roll resistant seal of claim 17 wherein said seal structure further includes a fourth flange substantially parallel to said second flange and proximate said inner edge of said annular carrier.

19. The roll resistant seal of claim 15 wherein said ribs are triangular.

20. The roll resistant seal of claim 15 wherein said seal structure includes an outer circumferential seal having a plurality of ribs.
